(19) United States
(12) Patent Application Publication
(10) Pub. No.: US 2003/0226521 A1
(43) Pub. Date: Dec. 11, 2003

(54) Toy with loop ends

(76) Inventor: Robert F. Dobihal, Minnetrista, MN (US)

Correspondence Address: John F. Klos, Esq., Fulbright & Jaworski L.L.P., Suite 4850, 225 South Sixth Street, Minneapolis, MN, 55402, US

(21) Appl. No.: 10/456,462

(22) Filed: Jun. 5, 2003

Related U.S. Application Data
(60) Provisional application No. 60/386,656, filed on Jun. 5, 2002.

(51) Int. Cl. A01K 29/00

(52) U.S. Cl. 119/709

(57) ABSTRACT

A toy with loop ends, finding particular applicability as a toy for an animal's use, especially for a dog or a cat. A cord loop is disposed within a body of the toy, with portions of the loop extending away from the body. Each loop portion extends outwardly from the body at a sufficient distance to be manipulated, for example, gripped in the teeth of a dog or a cat.

### RELATED APPLICATION

This application claims priority from U.S. Provisional Application No. 60/386,656 filed on Jun. 5, 2002, and hereby incorporated by reference in its entirety.

### FIELD OF THE INVENTION

Present invention relates generally to a toy. In particular, the present invention relates to a durable toy which is adapted to amuse animals such as a dog or cat.

### BACKGROUND OF THE INVENTION

Many animals, such as dogs and cats enjoy throwable play things. These prior animal play toys have been designed to occupy the animals in some sort of activity, such as chewing, gnawing, and pulling. These play things are designed for the animal to pick up and hold in its mouth, or to push with its nose or feet.

Since a pet toy is generally treated roughly and is typically carried in the animal's mouth, it is important to provide a play toy for animals which is safe and non-toxic to play and chew on. It is especially important that the toy not break apart in the animal's mouth. Pieces of the toy could easily fall into the pet's throat causing it to gag or choke.

To pique the interest of the animal, many pet toys are designed to imitate common creatures. Many are often designed to have a body with appendages extending from the body. Aside from making the toy appear more realistic to the animal, the appendages also offer an easy grasping point.

However, the appendage of a pet toy is often a weak point in the toy's design. This weakness is exacerbated by the fact that many pets will tug and pull on the appendages further weakening its point of attachment to the body of the toy. Consequently, it is a common problem in the prior art for the appendages to break off the body of the toy and possibly cause the pet to gag or choke. As such, there is a need in the art for a novel toy design wherein the appendages of the pet toy do not constitute a potential choking hazard to the pet.

### SUMMARY OF THE INVENTION

The present invention is a toy with loops specially adapted for an animal's use, in particular a dog or a cat. The toy is sized so that a dog or a cat will not be able to swallow it, and is made of durable material so that the animal can grip and pull on the toy.

In one embodiment, the toy is comprised of a body and a cord. The body is made of two parts sewn to each other along peripheral edges of the parts. The body may contain filling materials such as pellets or other materials to add bulk to the body. Noisemakers, such as air pillows, may also be disposed within the body.

In one embodiment, the cord forms a loop and is disposed within and attached to the body. The loop forms a plurality of loop portions which extend from the body. Each loop portion extends from each end such a distance that loop will allow it to be drawn a substantial distance into the animal's mouth for the animal to grab it.

### DESCRIPTION OF THE DRAWINGS

Preferred embodiments of the invention will be described in detail hereinafter with reference to the accompanying drawings, in which like reference numerals refer to like elements throughout.

FIG. 1 is a top view of the toy in a starfish profile shape with a top portion of the toy removed to disclose the cord disposed therein, with loop ends formed from a cord in a particular configuration.

FIG. 2 is a side elevational view of the toy of FIG. 1.

FIG. 3 is a top view of another embodiment of the toy in a starfish profile shape with loop ends formed from rope in another configuration.

FIG. 4 is a top view of another embodiment of the toy in a snake profile shape.

FIG. 5 is an alternative embodiment of the toy of FIG. 1, wherein the loops are interconnected.

### DETAILED DESCRIPTION OF THE INVENTION

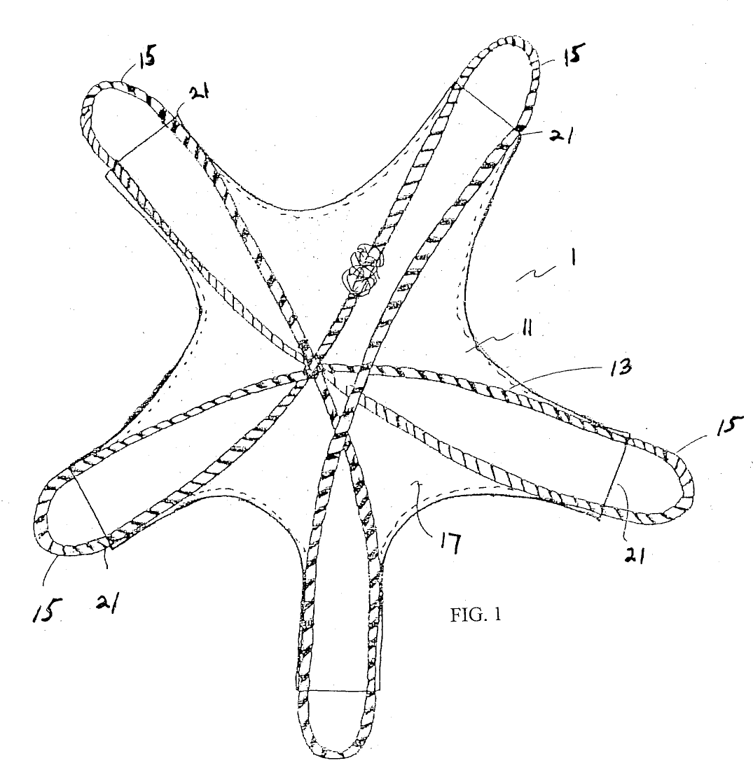

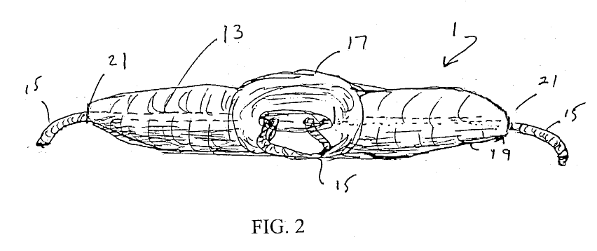

Referring to FIGS. 1 and 2, in one embodiment, the toy 1 in a starfish profile shape is shown. The toy 1 comprises of a body 11 and a cord 13. The body 11 is formed of any of a variety of tough materials depending upon the characteristics that are desired, including plastic, fleece, cloth, nylon to name a few. DuPont “CORDURA” nylon is an example of material that can be used for the body 11 of toy 1. The material for body 11 can be a water resistant material. The material should be resistance to tears and cuts.

In one embodiment, the body 11 is made of two parts 17 and 19 (not shown). Parts 17 and 19 are overlayed onto each other and sewn to each other along peripheral edges of the parts. Alternative securement approaches to sewing would be readily appreciated by those skilled in the relevant arts. It has also been contemplated that the body be formed in a known manner using a plastic injection molding technique. The body 11 may contain filling materials such as pellets or other materials to add bulk to the body. The body may also have noisemaking articles, such as air pillows (not shown) disposed within.

In one embodiment, the cord 13 forms a loop and is mostly disposed within the body 11. Loop portions 15 extend from ends 21 of body 11. Each loop portion is secured to an end 21 of the body. Alternatively, in one embodiment, the loop portion 15 is attached to the body in a manner which allows it to slide inwardly and outwardly from within the body. Each loop portion 15 extends from each end 19 such a distance that loop 15 will allow it to be drawn a substantial distance into the an animal's mouth for the animal to grab it. The loop portions 15 are sized small enough to prevent the animal from gagging on it.

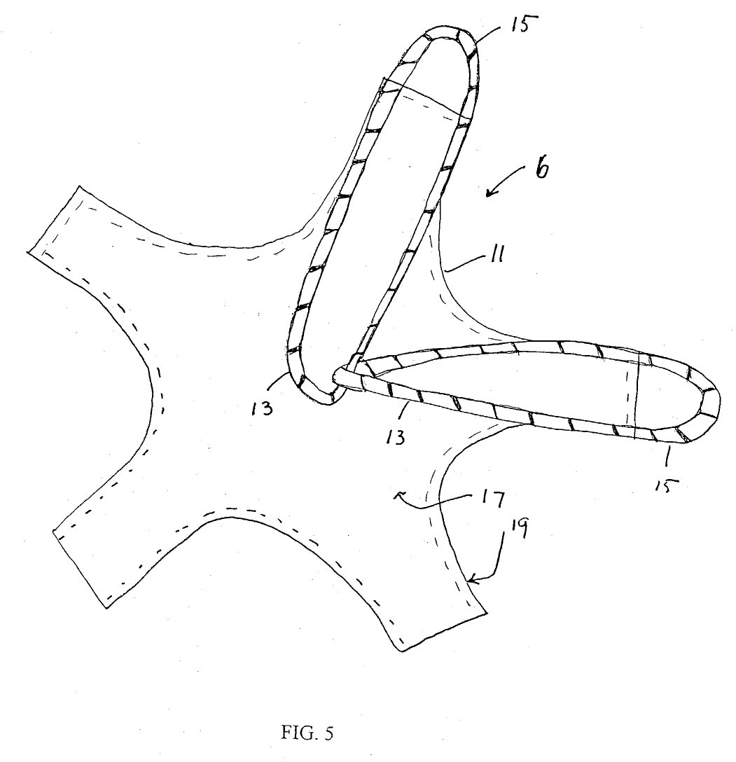

In one embodiment, the cord 13 is retained between two parts 17 and 19 of body 11. Cord 13 may be sewn to the inner face of parts 17 or 19 in a pattern as shown in FIG. 1. Non-toxic nylon is a form of material that can be used for the cord 13. The cross sectional of cord 13 can be round or any other shapes. Cord 13 may be a rope, string, or other elongated flexible element. Cord 13 may be manufactured from natural or synthetic products or a combination thereof. Preferably a single cord element is utilized to practice the invention. Alternatively, a plurality of cord elements may comprise cord 13. It is also contemplated (as shown in FIG. 5) that a plurality of interconnected loops be formed, with each loop having a loop portion extending from the body 11. FIG. 5 illustrates another embodiment of the present invention, toy 6.

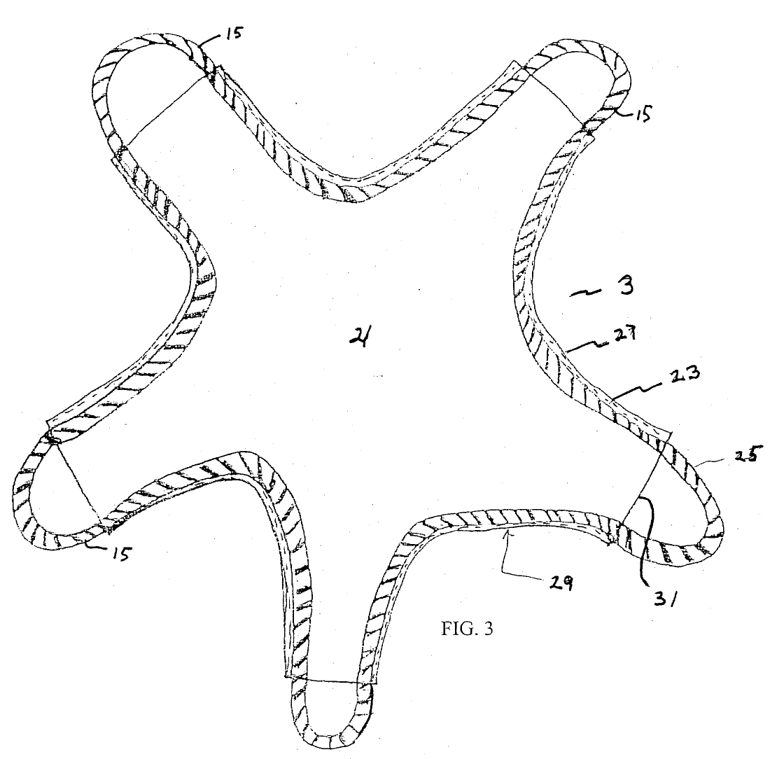

Referring to FIG. 3, in one embodiment, the toy 3 in a starfish profile shape is shown with an alternative routing attachment of rope 23 to body 21. In this configuration, the cord 23 is provided along the peripheral edge of parts 27 or 29. Similar to FIG. 1, cord 23 forms loop portions 25 extending from ends 31 of body 21.

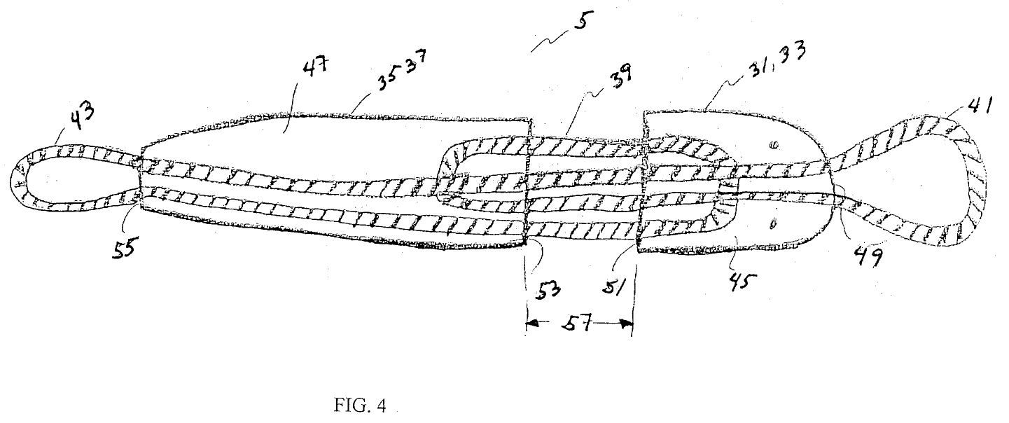

Referring to FIG. 4, in one embodiment, the present invention is in a snake profile shape. In this configuration, the toy 5 comprises head 45, body 47, and cord 39. The head 45 and body 47 are made of two layers of the covering material which are sewn or glued along each peripheral edge. Cord 39 is attached by sewing or gluing to the inside of head 45 and body 47. The cord 39 forms loops 41 and 43 extending from end 49 of head 45 and end 55 of body 47 respectively. Loop portions 41 and 43 extend from ends 49 and 55 respectively such a distance that they will allow them to be grasped in an animal's mouth.

The above described embodiments of the inventions are merely descriptive of its principles and are not to be considered limiting. Further modifications of the invention herein disclosed will occur to those skilled in the respective arts and all such modifications are deemed to be within the scope of the invention.

What is claimed is:

1. A toy comprising:
a body;
a loop disposed within the body and having separated first and second loop portions extending from separate areas of the body.

2. The toy of claim 1, wherein the body is comprised of a plush material.

3. The toy of claim 1, wherein the loop is made of a flexible cord.

4. The toy of claim 1, wherein the loop is made of a nylon rope.

5. The toy of claim 1 wherein a noise maker is disposed within the body.

6. The toy of claim 1, wherein the loop has more than two separated loop portions extending from the body.

7. The toy of claim 1, wherein filling material is disposed within the body.

8. The toy of claim 1, wherein the body is made of a plastic material.

9. The toy of claim 1, wherein the loop is slidably disposed within the body.

10. A method of making a toy comprising:
forming a body;
disposing a loop within the body so that separated first and second portions of the loop extend from separate areas of the body; and
retaining the loop to the body.

11. The method of claim 10, wherein the step of forming the body includes overlaying two separate pieces of plush material.

12. The method of claim 10, and further comprising disposing a noise maker within the body.

13. The method of claim 10, and further comprising disposing filling material within the body.

14. The method of claim 10, wherein the body is formed by a plastic injection molding process.

15. The method of claim 10, and further comprising the step of adding facial features on an exterior surface of the body.

16. A toy comprising:
a body;
a flexible cord disposed within the body, the cord having separated first and second cord portions extending from separate portions of the body.

17. The toy of claim 16, wherein the first and second cord portions each has a knotted portion.

18. The toy of claim 16, and further comprising facial features connected to an exterior surface of the body.

19. The toy of claim 16, wherein the body is made of fabric.

20. The toy of claim 16, wherein an air pillow is disposed within the body.

21. A toy comprising:
a body; and
a plurality of loops disposed within the body, with each loop being interconnected to another loop; and wherein each loop has a loop portion extending from the body.
